(19) United States
(12) Patent Application Publication
(10) Pub. No.: US 2008/0254835 A1
(43) Pub. Date: Oct. 16, 2008

(54) SYSTEM AND METHOD FOR A PORTABLE COMMUNICATION DEVICE TO ...

(75) Inventor: Anders Mellqvist, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/854,688

(22) Filed: Sep. 13, 2007

Related U.S. Application Data
(60) Provisional application No. 60/910,878, filed on Apr. 10, 2007.

(51) Int. Cl. H04B 1/38

(52) U.S. Cl. 455/559; 455/557

(57) ABSTRACT

A system and a method for a portable communication device to receive and transmit information (e.g., place and receive telephone calls, transmit and receive E-mail messages, SMS messages, Internet communications, etc.) through an unlicensed mobile access network, when such network is available. When the unlicensed mobile access network is unavailable, the user may transmit and receive such information through the mobile cellular network.

### RELATED APPLICATION DATA

This application claims the benefit of U.S. Provisional Application No. 60/910,878 filed Apr. 10, 2007, which is incorporated herein by reference.

### TECHNICAL FIELD OF THE INVENTION

The present invention relates generally to the field of mobile telephony. More specifically, the present invention relates to a mobile portable communication device and a method of accessing an unlicensed mobile access network.

### DESCRIPTION OF THE RELATED ART

Mobile portable communication devices (e.g., mobile telephones) have evolved from voice-only electronic devices to multi-functional electronic devices. For example, mobile telephones may now function as electronic organizers, digital cameras, audio applications (e.g., MP3 players), video applications (e.g., video players), video game terminals, etc. Moreover, mobile telephones are not only used for voice communications, but they also are used in a variety of other forms (e.g., in instant messaging applications, sharing photographs, gaining access to information on the Internet, etc).

With this outgrowth of device functionality, there has been an increased demand for operator network services. Exemplary operator network services include: electronic mail (E-mail, Internet access, subscription services, game services, etc. With this increased demand for additional services, there is generally an increased cost to the consumer for using the additional services provided by the network operator. In many instances, the cost of electronic communications over a mobile telephone infrastructure is much more expensive than comparable services over a local area network (LAN) and/or wireless local area network (WLAN) used by a personal computer. For example, many network operators not only charge subscribers for a particular service, but they also may charge the subscriber based on the number of bytes transferred over the mobile telephone network.

One drawback with conventional portable communication devices is the difficulty in utilizing the portable communication devices with other networks, especially networks having free and/or reduced costs. Another drawback with conventional portable communication devices is the difficulty configuring the device to receive telephony information through an external electronic device and route the information to the portable communication device. Still another drawback, is configuring the portable communication device to receive information from the external electronic device when the external device is connected to an unlicensed network and receive information from a mobile telephony network when the unlicensed network is unavailable.

### SUMMARY

In view of the aforementioned shortcomings, there is a need in the art for a system and a method for a portable communication device to receive and transmit information (e.g., place and receive telephone calls, transmit and receive E-mail messages, SMS messages, Internet communications, etc.) through an unlicensed mobile access network, when such network is available. When the unlicensed mobile access network is unavailable, the user may transmit and receive such information through the mobile cellular network.

According to one aspect of the invention, the invention is directed to a portable communication device comprising: a memory; a universal port for coupling the universal port to an associated external electronic device that is configured to communicate with an unlicensed mobile access network; a processor that executes an application program within the memory, the application program when executed causing the portable communication device to: transmit a request for services to the external electronic device through the universal port; and establish a logical connection between the portable communication device and the unlicensed mobile network, wherein the portable communication device may receive and transmit calls over the unlicensed mobile network.

According to another aspect of the invention, the universal port is a universal serial bus port.

According to another aspect of the invention, a universal serial bus cable is removably attached to the universal serial port for coupling the portable communication device to the associated external electronic device.

According to another aspect of the invention, the portable communication devices includes a local interface adapter for communicating between the portable communication device and a headset.

According to another aspect of the invention, the local interface adapter is a Bluetooth-compatible adapter.

According to another aspect of the invention, the Bluetooth-compatible adapter is configured to communicate with a wireless headset.

According to another aspect of the invention, the local interface adapter is configured to accept a wired headset.

According to another aspect of the invention, the application program further causes the portable communications device to synchronize information stored on the portable communication device with information stored on the external electronic device.

According to another aspect of the invention, when the unlicensed mobile access network is unavailable to the portable communications device, the application program further causes the portable communications device to establish a logical connection between the portable communication device and a cellular network the unlicensed mobile network, wherein the portable communication device may receive and transmit calls over the unlicensed mobile network.

According to another aspect of the invention, the external electronic device is a personal computer.

Another aspect of the invention relates to a method of connecting a portable communications device to an unlicensed mobile access network, the method comprising: providing a portable communication device having a memory, an application program stored in the memory, a universal port and a processor coupled to the memory and the universal port; coupling the portable communication device through the universal port to an external electronic device, wherein the external electronic device is configured to communicate with a wide area network through an unlicensed mobile access network; and wherein upon coupling the portable communication device through the universal port to the external electronic device causing the processor to execute the application program within the memory, the application program when executed causing the portable communications device to: transmit a request for services to the external electronic device through the universal port; and establish a logical connection between the portable communication device and the unlicensed mobile access network, wherein the portable communication device may receive and transmit calls over the unlicensed mobile access network.

According to another aspect of the invention, when a connection to the unlicensed mobile access network is unavailable, the portable communication device establishes a connection with a mobile cellular network.

According to another aspect of the invention, the universal port is a universal serial bus port.

According to another aspect of the invention, a universal serial bus cable is removably attached to the universal port for coupling the portable communication device to the associated external electronic device.

According to another aspect of the invention, including providing a local interface adapter coupled to the processor for receiving and transmitting communication signals between the portable communication device and a headset.

According to another aspect of the invention, the local interface adapter is a Bluetooth-compatible adapter that is configured to communicate with a wireless headset.

According to another aspect of the invention, the local interface adapter is configured to accept a wired headset.

According to another aspect of the invention, including synchronizing information stored on the portable communication device with information stored on the external electronic device.

According to another aspect of the invention, including synchronizing information stored on the external electronic device with information stored on the portable communication device.

Another aspect of the invention relates to a computer program stored on a machine readable medium, the program being suitable for use in a portable communication device as communication application, wherein: when the portable communication device is coupled to an external electronic device and the communication application is loaded in memory in the portable communication device and executed causes the portable communications device to: transmit a request for services to the external electronic device through the universal port; and establish a logical connection between the portable communication device and an unlicensed mobile access network, wherein the portable communication device may receive and transmit calls over the unlicensed mobile access network.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal, includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIGS. 1 and 2 are exemplary schematic diagrams illustrating electronic equipment in accordance with aspects of the present invention.

FIG. 3 is an exemplary network in accordance with aspects of the present invention.

FIG. 4 is an exemplary method in accordance with aspects of the present invention.

### DETAILED DESCRIPTION OF EMBODIMENTS

The present invention relates to a system and method for a portable communication devices to receive and transmit information (e.g., place and receive telephone calls, transmit and receive E-mail messages, SMS messages, Internet communications, etc.) through an unlicensed mobile access network, when such network is available. When the unlicensed mobile access network is unavailable, the user may transmit and receive such information through the mobile cellular network.

The present invention is described primarily in the context of a mobile telephone. However, it will be appreciated that the invention is not intended to relate solely to mobile telephones, but can relate to any type of portable communication devices.

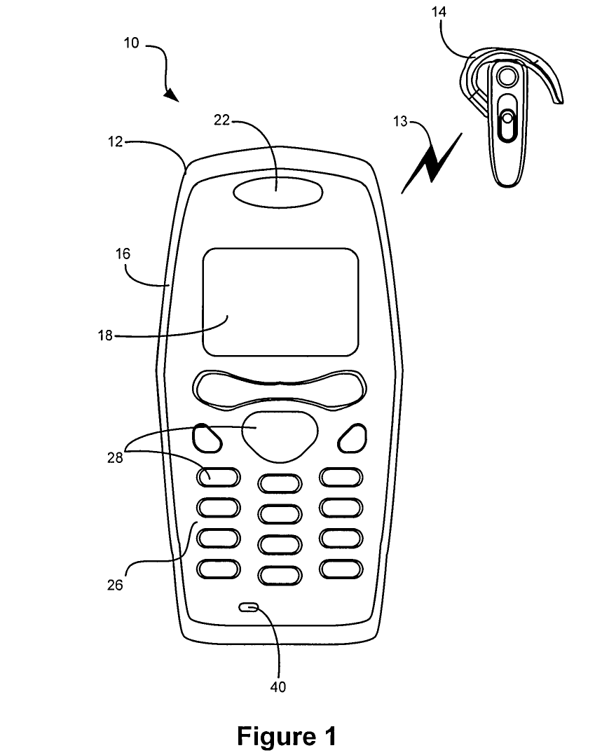

Referring to FIG. 1, a mobile telephone assembly 10 is shown in accordance with the present invention. The illustrated mobile telephone assembly 10 includes a mobile telephone 12 and a rendering device 14 (e.g., a headset) coupled to the mobile telephone 12. The mobile telephone 12 is shown as having a “brick” or “block” design type housing 16, but it will be appreciated that other type housings, such as a clamshell housing or a slide-type housing, may be utilized without departing from the scope of the invention.

The rendering device 14 in the exemplary embodiment is a rendering device in the form of a headset and will be referred to as the headset 14. The headset 14 is shown as an ear mountable speaker and microphone assembly that exchanges audio data with the mobile telephone 12 over a communication link 13. The communication link 13 may be a wired communication link or a wireless communication link. One of ordinary skill in the art will appreciate that any rendering device operable to receive signals discussed herein is deemed to fall within the scope of the present invention. For example, suitable rendering devices include headphones, earphones, speakers and the like.

For purposes of the description herein, the communication link 13 between the mobile telephone 12 and the headset 14 may be established using a Bluetooth protocol, such as in accordance with the Specification of the Bluetooth System, Covered Core Package version 2.0+EDR, dated Nov. 4, 2004, which is incorporated herein by reference in its entirety. Other suitable wireless interfaces (e.g., radio frequency, 802.11 compatible protocols, infrared, etc.) also may be used to transmit data to the mobile telephone 12 and/or to the headset 14.

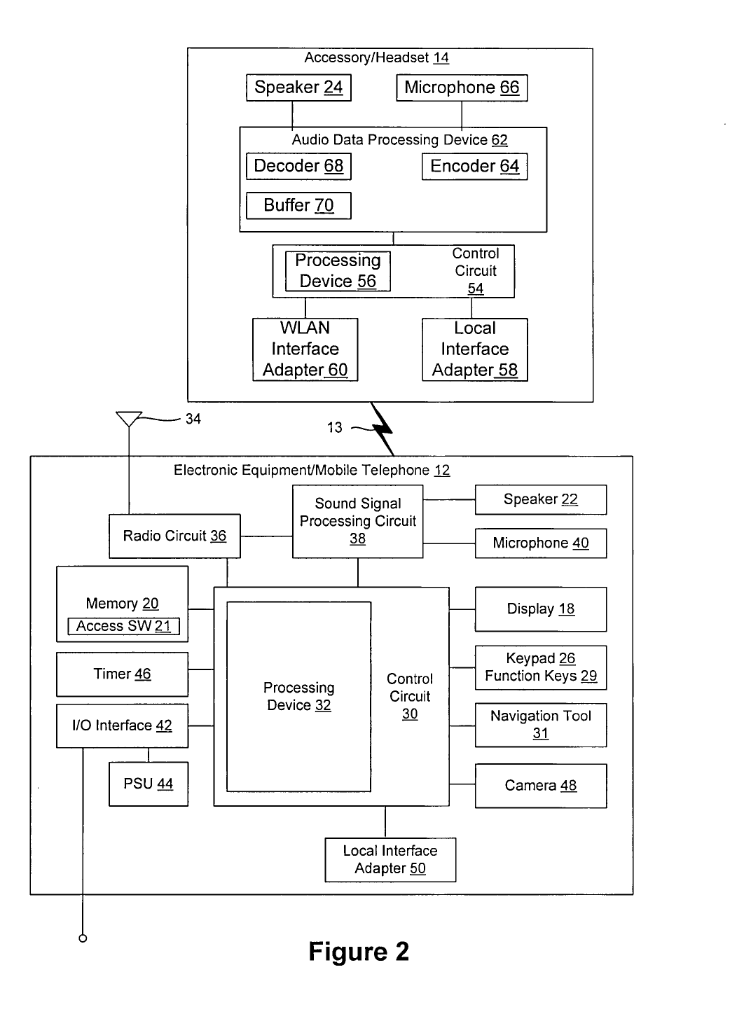

The mobile telephone 12 includes a display 18. The display 18 displays information to a user such as operating state, time, telephone numbers, contact information, various navigational menus, etc., which enables the user to utilize the various feature of the mobile telephone 12. The display 18 may also be used to visually display content accessible by the mobile telephone 12 and/or headset 14 from one or more remote sources (e.g., a media server, a network, etc.). The displayed content may include audio and/or video presentations stored locally in memory 20 (FIG. 2) of the mobile telephone 12 and/or stored remotely from the mobile telephone 12 (e.g., on a remote storage device, a media server, remote personal computer, etc.). Such presentations may be derived, for example, from multimedia files, including audio and/or video files, from a received mobile radio and/or television signal, etc. In many situations, the video presentations are accompanied by audio presentations. For example, the displayed video component may be a “music video” and the corresponding audio component may be music intended to be synchronized with the video component. As another example, the displayed video component may correspond to a received mobile television signal and the corresponding audio component may be speech and/or music intended to be synchronized with the video component.

The audio component may be broadcast to the user with a speaker 22 of the mobile telephone 12. Alternatively, the audio component may be broadcast to the user with a speaker 24 (FIG. 2) of the headset 14. For stereo listening, the headset 14 may include a pair of speakers 24. Delivery of audio data from the content source to the mobile telephone 12 and/or the headset 14 will be described in greater detail below.

The mobile telephone 12 further includes a keypad 26 that provides for a variety of user input operations. For example, the keypad 26 may include alphanumeric keys 28 for allowing entry of alphanumeric information such as telephone numbers, phone lists, contact information, notes, etc. In addition, the keypad 26 typically may include special function keys 29 such as a “call send” key for initiating or answering a call, and a “call end” key for ending, or “hanging up” a call. A navigation tool 31 may also be included to allow the user to easily toggle and or move a cursor on the display and/or for assisting a user to navigate through a menu displayed on the display 18 to select different telephone functions, profiles, settings, etc., as is conventional. Other keys associated with the mobile telephone 12 may include a volume key, audio mute key, an on/off power key, a web browser launch key, a camera key, etc. Keys or key-like functionality may also be embodied as a touch screen associated with the display 18.

The mobile telephone 12 includes conventional call circuitry (e.g., radio circuit 36) that enables the mobile telephone 12 to establish a call and/or exchange signals with a called/calling device, typically another mobile telephone or landline telephone. However, the called/calling device need not be another telephone, but may be some other device such as an Internet web server, content providing server, etc.

Continuing to refer to FIGS. 1 and 2, the mobile telephone 12 includes an antenna 34 coupled to a radio circuit 36. The radio circuit 36 includes a radio frequency transmitter and receiver for transmitting and receiving signals via the antenna 34 as is conventional. The mobile telephone 12 generally utilizes the radio circuit 36 and antenna 34 for voice, Internet and/or E-mail communications over a cellular telephone network. The mobile telephone 12 further includes a sound signal processing circuit 38 for processing the audio signal transmitted by/received from the radio circuit 36. Coupled to the sound processing circuit 38 are the speaker 22 and a microphone 40 that enable a user to listen and speak via the mobile telephone 10 as is conventional. The radio circuit 36 and sound processing circuit 38 are each coupled to the control circuit 30 so as to carry out overall operation.

Referring to FIG. 2, a functional block diagram of the electronic equipment assembly 10 is illustrated. The mobile telephone 12 includes a primary control circuit 30 that is configured to carry out overall control of the functions and operations of the mobile telephone 12. The control circuit 30 may include a processing device 32, such as a CPU, microcontroller or microprocessor. The processing device 32 executes code stored in a memory (not shown) within the control circuit 30 and/or in a separate memory, such as memory 20, in order to carry out conventional operation of the mobile telephone 12. The memory 20 may be, for example, a buffer, a flash memory, a hard drive, a removable media, a volatile memory and/or a non-volatile memory. In addition, the processing device 32 executes code to carry out various functions of the mobile telephone 12.

The memory 20 may include an access software application 21 for controlling the network selected by the mobile telephone 12. For example, when an unlicensed mobile access network is detected, software application 21 may configure or otherwise command processor to execute, which causes the mobile telephone to transmit a request for services to the external electronic device through the universal port; and establish a logical connection between the portable communication device and the unlicensed mobile network, wherein the portable communication device may receive and transmit calls over the unlicensed mobile network. In general, the logical connection is established by storing the subscriber's current location information in the core network. This information may be periodically updated based upon one or predetermined events (e.g., roaming, loss of UMA network access, etc.).

Continuing to refer to FIGS. 1 and 2, the mobile telephone 12 includes an antenna 34 coupled to a radio circuit 36. The radio circuit 36 includes a radio frequency transmitter and receiver for transmitting and receiving signals via the antenna 34 as is conventional. The mobile telephone 12 further includes a sound signal processing circuit 38 for processing the audio signal transmitted by/received from the radio circuit 36. Coupled to the sound processing circuit 38 are the speaker 22 and a microphone 40 that enable a user to listen and speak via the mobile telephone 12 as is conventional. The radio circuit 36 and sound processing circuit 38 are each coupled to the control circuit 30 so as to carry out overall operation.

The mobile telephone 12 also includes the aforementioned display 18, keypad 26, function keys 29 and navigation tool 31 coupled to the control circuit 30. The mobile telephone 12 further includes an I/O interface 42. The I/O interface 42 may be in the form of typical mobile telephone I/O interfaces, such as a multi-element connector at the base of the mobile telephone 12. As is typical, the I/O interface 42 may be used to couple the mobile telephone 12 to a battery charger to charge a power supply unit (PSU) 44 within the mobile telephone 12. In addition, or in the alternative, the I/O interface 42 may serve to connect the mobile telephone 12 to a wired personal hands-free adaptor, to an external electronic device (e.g., personal computer or other device) via a data cable, etc. For example, the I/O interface 42 may be a universal port that may be coupled to a cable to connect the mobile telephone 12 to a personal computer. The universal port may be a universal serial bus (USB) port, which receives a USB cable for connection to a USB port of a personal computer.

The mobile telephone 12 may also include a timer 46 for carrying out timing functions. Such functions may include timing the durations of calls, generating the content of time and date stamps, etc.

The mobile telephone 12 may include various built-in accessories, such as a camera 48 for taking digital pictures. Image files corresponding to the pictures may be stored in the memory 20. In one embodiment, the mobile telephone 12 also may include a position data receiver (not shown), such as a global positioning satellite (GPS) receiver, Galileo satellite system receiver or the like.

To establish wireless communication with other locally positioned devices, such as the headset 14, another mobile telephone, a computer, etc., the mobile telephone 12 may include a local wireless interface adapter 50, such as a Bluetooth adaptor. The wireless interface adapter 50 will generally enable the mobile telephone 12 to communicate with a variety of electronic devices (e.g., a wireless headset 14).

The mobile telephone 12 may be configured to operate in a wide area communications system. The system may include one or more servers or call control elements for managing calls placed by and destined to the mobile telephone 12, transmitting information (e.g., call information, network-based content, image files, audio files, video files, etc.) to the mobile telephone 12 and carrying out any other support functions. The server may communicate with the mobile telephone 12 via a network and a transmission medium. The transmission medium may be any appropriate device or assembly, including, for example, a communications tower, another mobile telephone, a wireless access point, a router, a satellite, etc. Portions of the network may include wired and/or wireless transmission pathways.

Referring to FIG. 2, the headset 14 includes a primary control circuit 54 that is configured to carry out overall control of the functions and operations of the headset 14. The control circuit 54 may include a processing device 56, such as a CPU, microcontroller or microprocessor. The processing device 56 executes code stored in a memory (not shown) within the control circuit 54 and/or in a separate memory, such as memory (not shown), in order to carry out operation of the headset 14, as described herein. The memory may be, for example, a buffer, a flash memory, a hard drive, a removable media, a volatile memory and/or a non-volatile memory. In addition, the processing device 56 executes code to carry out various functions of the headset 14.

The headset 14 includes a local interface adapter 58 that may be compatible with the local interface adapter 50 of the mobile telephone 12 to establish a wireless interface between the headset 14 and the mobile telephone 12. The local interface adapter 58 may be coupled to the control circuit 54 to selectively control and process information and/or data received and/or transmitted by the local interface adapter 58. Preferably, as discussed above, the local interface adapter 58 is Bluetooth compatible. The wireless interface established between adapters 50 and 58 may be used to exchange data, such as audio data, commands, control and/or status information between the mobile telephone 12 and the headset 14. One of ordinary skill in the art will understand the basic operations of a Bluetooth wireless communication interface, so the details will not be described here in detail for the sake of brevity.

The headset 14 further includes an input/output (I/O) interface 60 for connecting the headset to the mobile telephone 12 and/or another electronic device (not shown) through a wired connection. The I/O interface 60 is coupled to the control circuit 54 to selectively control and process information and/or data received and/or transmitted by the I/O Interface 60.

The headset 14 further includes an audio data processing device 62 that manages audio data. For example, the audio data processing device 62 may include an encoder 64 that encodes an audio signal received from a microphone 66 coupled to the headset 14. Encoded audio data may be transmitted to the mobile telephone 12 for use as part of a telephone call. In addition, the audio data processing device 62 may include a decoder 68 and a data buffer 70 to process audio data received from the mobile telephone 12.

The received audio data may be incoming audio data associated with a telephone call. In other situations, the audio data received by the headset 14 may be audio (e.g., music, sound, voice, etc.) derived from an audio file played back by the mobile telephone 12. The audio data received by the headset 14 may also be network-based content, which originated from one or more devices associated with a network. In yet other situations, the audio data may be associated with video content displayed on the display 18 of the mobile telephone 12. For example, a video file containing an audio component stored in the memory 20 and/or stored remotely on a network (e.g., network-based content) may be rendered by the mobile telephone 12.

In such situations, the video component of the video file or received video signal may be decoded by, for example, the control circuit 30 or dedicated video decoder (not shown) to generate a video signal output to the display 18 for viewing. The audio component of the video file or received video signal may be decoded and delivered as an audio signal to the speaker 22 and/or the audio component may be transmitted as audio data to the headset 14 for decoding into an audio signal that is broadcast by the speaker 24.

Audio data transmitted from the mobile telephone 12 to the headset 14 is typically in the form of media packets. Each media packet may contain a quantity of audio data, such as about 5 milliseconds of audio data. The audio data may be buffered by the buffer 62 and decoded by the decoder 60 into an audio signal for delivery to the speaker 24. As will be appreciated, the audio data may be mono, stereo or surround-sound, or arranged in any other suitable audio format.

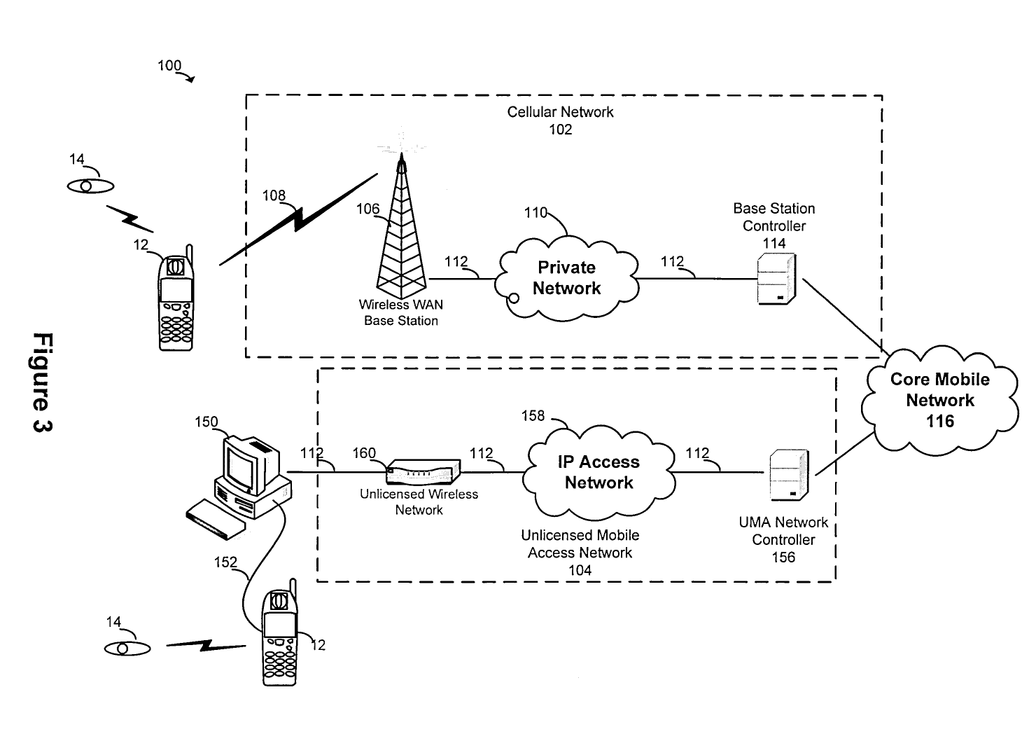

An exemplary system 100 in accordance with the present invention is illustrated in FIG. 3. The system 100 conceptually illustrates extending mobile services to an unlicensed spectrum. In general, unlicensed mobile access (UMA) technology provides access to a wide variety of mobile services, including for example, global system for mobile communication (GSM) and general packet radio service (GPRS) mobile services over unlicensed spectrum technologies. Exemplary unlicensed spectrum technologies include, for example, universal serial bus (USB), Bluetooth-compliant and IEEE 802.11-compliant bearers. By deploying UMA technology, network service providers may enable mobile subscribers to roam and handover between cellular networks and public and private unlicensed wireless networks using dual-mode mobile telephones. In general operation, subscribers receive a consistent user experience for their mobile voice and data services as they transition between networks the UMA network and the cellular network. That is, the network accessed by the mobile telephone is generally transparent to the user.

As shown in FIG. 3, the exemplary system 100 includes a cellular network 102 and an UMA network 104. The cellular network 102 and the UMA network 104 are identified in dashed lines, respectively. The networks are exemplary in nature and may take a variety of forms and/or architectures.

Communication over the cellular network 102 is generally as follows. The user of the mobile telephone 12 enters the telephone number desired to be called or other information to be accessed (e.g., e-mail address, website, SMS message, etc.). The information may be routed to the wireless wide are network (WAN) base station 106 through a wireless communication link 108. The communication link 108 can take the form of any medium that permits electronic devices to exchange information or data wirelessly. Generally, the communication link 108 is capable of supporting GSM and GPRS communications.

From the base station 106, the information is routed to the private network 110 through a communication link 112. The communication link 112 may be any type of communication link functional to provide the desired functionality described herein. In addition, one or more addition WAN base stations may be included in the cellular network 102 to provide a wider area of cellular network coverage.

The private network 110 is generally owned and/or licensed by the service provider in which the user of the mobile telephone 12 is a subscriber. The information is then routed to the base station controller 114 for transmission to the core mobile network 1116. The core mobile network 1116 may handle a variety of communications. For example, the circuit core may handle real time communications (e.g., voice communications); the packet core may handle data services; the multimedia core may handle communications services comprising, for example, voice and shared multimedia content within the same session; and the user management core may handle information about subscribers and providing them with access to different types of services.

Once the information is routed to the mobile core network 1116, the information may be transmitted to the desired source (e.g. a mobile telephone, a landline, a content server, a network application, etc.) in a conventional manner (e.g., through the mobile network, transferred to a public switched telephone network (PSTN), etc.).

Likewise, calls placed to the mobile telephone 12 are handled by checking the information available at the core mobile network 116 associated with the mobile telephone 12. The calls are then forwarded based on the information made available at the core mobile network 116.

Communication over the UMA network 102 generally occurs as follows. The mobile telephone 12 is connected to a personal computer 150. Generally, the mobile telephone 12 is connected to the personal computer 150 through a cable 152 (e.g., a USB cable). The cable 152 may have a first end for connecting to the I/O Interface 42 of the mobile telephone 12 and a second end for connecting the cable 152 to the personal computer 150. In one embodiment, the cable 152 has USB connectors on each end to couple the mobile telephone 12 with the personal computer 150.

Once connected to the personal computer 150 and authenticated with the core mobile network 1116, all communications transmitted from the mobile telephone and destined to the mobile telephone 12 will be routed through the UMA network 102 and the personal computer 150 to the mobile telephone 12, unless the UMA network 104 is unavailable.

For example, once a mobile subscriber connects the mobile telephone 12 to the personal computer 150, the mobile telephone 12 causes a signal to contacts the UMA network controller (UNC) 156 over the broadband IP access network 158 (through the unlicensed network router 160) to be authenticated and authorized to access GSM voice and/or GPRS data services at the core mobile network 116 via the unlicensed wireless network 104. The communication link 108 between the personal computer and the network router 160 may be any desired communication link, including a wired and/or a wireless communication link. For instance, the communication link 108 may be a wired communications medium, such as Ethernet or a wireless communications medium, such as IEEE 802.11(a), 802.11(b) or 802.11(g). In addition, the communication link 102 may also be a combination of wired and wireless communications mediums.

If the mobile telephone 12 is properly authenticated, the subscriber's current location information stored in the core network is updated, and from that point on all mobile voice and data traffic is routed to the handset via the UMA network 104, rather than the cellular network 102. If the mobile telephone 12 is not authenticated, the mobile telephone may use the cellular network 102 for communication purposes.

If after establishing a connection between the mobile telephone 12 and the UMA network 104 and the connection to the UMA network 104 is lost, information including voice, call or data session can be automatically handover to the cellular network 102. Thus, the networks 102, 104 may switched during a voice, call or data session without any discernable service interruption.

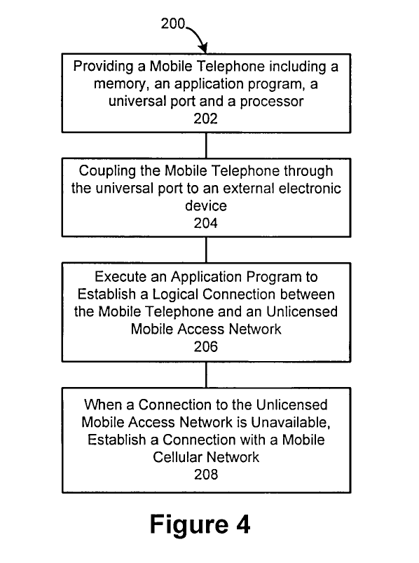

Referring to FIG. 4, an exemplary method 200 for connecting a portable communication device to an unlicensed mobile access network in accordance with one aspect of the present invention is illustrated. At step 202, a mobile telephone 12 is provided. The mobile telephone 12 includes a memory, an application program stored in the memory, a universal port and a processor coupled to the memory and the universal port. At step 204, the user couples the mobile telephone 12 through the universal port of the mobile telephone 12 to an external electronic device (e.g., personal computer 150). The external electronic device is generally configured to communicate with a unlicensed mobile access network.

At step 206, upon coupling the mobile telephone 12 through the universal port to the external electronic device causes the processor 32 to execute the application program 21 within the memory. The application program 21 when executed causes the mobile telephone 12 to: transmit a request for services to the external electronic device through the universal port 42; and establish a logical connection between the mobile telephone 12 and the unlicensed mobile access network 104. The mobile telephone 12 is then able to receive and transmit calls over the unlicensed mobile access network.

At step 208, when a connection to the unlicensed mobile access network is unavailable, the portable communication device establishes a connection with a mobile cellular network.

In addition to communicating with the cellular network 102 and the UMA network 104, there are additional benefits from coupling the mobile telephone 12 to the external electronic device (e.g., personal computer 150). For example, information stored on the external electronic device may be synchronized with information stored on the mobile telephone 12. In addition, information stored on the mobile telephone 12 may be synchronized with information stored on the external electronic device.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A portable communication device comprising:
a memory;
a universal port for coupling the universal port to an associated external electronic device that is configured to communicate with an unlicensed mobile access network;
a processor that executes an application program within the memory, the application program when executed causing the portable communication device to:
transmit a request for services to the external electronic device through the universal port; and
establish a logical connection between the portable communication device and the unlicensed mobile network, wherein the portable communication device may receive and transmit calls over the unlicensed mobile network.

2. The portable communication device of claim 1, wherein the universal port is a universal serial bus port.

3. The portable communication device of claim 2, wherein a universal serial bus cable is removably attached to the universal serial port for coupling the portable communication device to the associated external electronic device.

4. The portable communication device of claim 1 further including a local interface adapter for communicating between the portable communication device and a headset.

5. The portable communication device of claim 4, wherein the local interface adapter is a Bluetooth-compatible adapter.

6. The portable communication device of claim 5, wherein the Bluetooth-compatible adapter is configured to communicate with a wireless headset.

7. The portable communication device of claim 4, wherein the local interface adapter is configured to accept a wired headset.

8. The portable communication device of claim 1, wherein the application program further causes the portable communications device to synchronize information stored on the portable communication device with information stored on the external electronic device.

9. The portable communication device of claim 1, wherein when the unlicensed mobile access network is unavailable to the portable communications device, the application program further causes the portable communications device to establish a logical connection between the portable communication device and a cellular network the unlicensed mobile network, wherein the portable communication device may receive and transmit calls over the unlicensed mobile network.

10. The portable communication device of claim 1, wherein the external electronic device is a personal computer.

11. A method of connecting a portable communications device to an unlicensed mobile access network, the method comprising:
providing a portable communication device having a memory, an application program stored in the memory, a universal port and a processor coupled to the memory and the universal port;
coupling the portable communication device through the universal port to an external electronic device, wherein the external electronic device is configured to communicate with a wide area network through an unlicensed mobile access network; and
wherein upon coupling the portable communication device through the universal port to the external electronic device causing the processor to execute the application program within the memory, the application program when executed causing the portable communications device to:
transmit a request for services to the external electronic device through the universal port; and
establish a logical connection between the portable communication device and the unlicensed mobile access network, wherein the portable communication device may receive and transmit calls over the unlicensed mobile access network.

12. The method of claim 11 further including when a connection to the unlicensed mobile access network is unavailable, the portable communication device establishes a connection with a mobile cellular network.

13. The method of claim 11, wherein the universal port is a universal serial bus port.

14. The method of claim 13, wherein a universal serial bus cable is removably attached to the universal port for coupling the portable communication device to the associated external electronic device.

15. The method of claim 11 further including providing a local interface adapter coupled to the processor for receiving and transmitting communication signals between the portable communication device and a headset.

16. The method of claim 15, wherein the local interface adapter is a Bluetooth-compatible adapter that is configured to communicate with a wireless headset.

17. The method of claim 15, wherein the local interface adapter is configured to accept a wired headset.

18. The method of claim 11 further including synchronizing information stored on the portable communication device with information stored on the external electronic device.

19. The method of claim of claim 11 further including synchronizing information stored on the external electronic device with information stored on the portable communication device.

20. A computer program stored on a machine readable medium, the program being suitable for use in a portable communication device as communication application, wherein:
when the portable communication device is coupled to an external electronic device and the communication application is loaded in memory in the portable communication device and executed causes the portable communications device to:
transmit a request for services to the external electronic device through the universal port; and
establish a logical connection between the portable communication device and an unlicensed mobile access network, wherein the portable communication device may receive and transmit calls over the unlicensed mobile access network.
